(19) United States
(12) Patent Application Publication
(10) Pub. No.: US 2026/0339099 A1
(43) Pub. Date: Oct. 29, 2026

(54) OUTPUT COUPLING GRATINGS WITH INTEGRATED RECYCLING STRUCTURES FOR WAVEGUIDE-BASED DISPLAYS

(71) Applicant: SONY GROUP CORPORATION, Tokyo (JP)

(72) Inventors: Kazue SHIMIZU, Kanagawa (JP); Sebastien DE CUNSEL, Atsugi (JP); Christophe PEROZ, Tokyo (JP)

(73) Assignee: SONY GROUP CORPORATION, Tokyo (JP)

(21) Appl. No.: 19/110,656

(22) PCT Filed: Sep. 14, 2023
(86) PCT No.: PCT/JP2023/033495

§ 371 Date: Mar. 11, 2025

Related U.S. Application Data
(60) Provisional application No. 63/408,999, filed on Sep. 22, 2022.

(51) Int. Cl. G02B 27/01; G02B 5/18; G02B 27/00

(52) U.S. Cl. CPC G02B 27/0172; G02B 5/1823; G02B 5/1842; G02B 27/0081; G02B 2027/0118; G02B 2027/0178

(57) ABSTRACT

A recycler grating for a waveguide-based display comprises a base substrate and a plurality of photonic structures arranged into groups of unit cells on the base substrate. For unit cells in a first group, each unit cell comprises a length measured in a first direction, a width measured in a second direction substantially perpendicular to the first direction, and first, second, third, and fourth sides. The first and second sides are parallel to one another and extend in a third direction, and the third and fourth sides are parallel to one another and extend in a fourth direction substantially perpendicular to the third direction. In addition, each unit cell comprises at least two photonic structures that are spaced apart from one another in at least one section along a first cut line that extends in one of the first to fourth directions.

### TECHNICAL FIELD

Example embodiments relate to output coupling gratings (OCGs) with integrated recycling structures for waveguide-based displays.

### BACKGROUND ART

Waveguide-based displays may be used for near-eye display devices such as head mounted display (HMD) devices in augmented reality (AR) and/or mixed reality (MR) applications. Coupling of light at the input and the output of a waveguide affects the quality of image as seen by a user of a HMD.

### SUMMARY

An illustrative embodiment is directed to a recycler grating for a waveguide-based display comprising a base substrate and a plurality of photonic structures arranged into groups of unit cells on the base substrate. For unit cells in a first group, each unit cell comprises a length measured in a first direction, a width measured in a second direction substantially perpendicular to the first direction, and first, second, third, and fourth sides. The first and second sides are parallel to one another and extend in a third direction, and the third and fourth sides are parallel to one another and extend in a fourth direction substantially perpendicular to the third direction. In addition, each unit cell comprises at least two photonic structures that are spaced apart from one another in at least one section along a first cut line that extends in one of the first to fourth directions.

Another illustrative embodiment is directed to a waveguide for a display comprising an output coupling grating (OCG) that outputs light to an eyebox of the display, and a recycler grating that recycles light to the OCG and that outputs light to the eyebox.

Yet another illustrative embodiment is directed to a head mounted display (HMD) a light source, and a waveguide comprising an input coupling grating (ICG) that receives light from the light source, an output coupling grating (OCG) that outputs light to an eyebox of the HMD, and a recycler grating that recycles light to the OCG and that outputs light to the eyebox.

### BRIEF DESCRIPTION OF DRAWINGS

FIG. 1 is a block diagram of a system according to at least one example embodiment.

FIG. 2A illustrates a schematic view of a display device and an example of a k-space design diagram for the display device according to at least one example embodiment.

FIG. 2B illustrates schematic plan and cross-sectional views of a display device that includes an integrated recycler grating according to at least one example embodiment.

FIG. 2C illustrates additional cross-sectional views of example structures for a display device according to at least one example embodiment.

FIG. 3 illustrates a k-space design 204 that defines a unit cell according to at least one example embodiment.

FIG. 4A illustrates a schematic structure of a grating including a plurality of unit cells according to at least one example embodiment.

FIG. 4B shows various other details for a grating according to at least one example embodiment.

FIGS. 5A and 5B illustrate example divisions within unit cells and corresponding photonic structures according to at least one example embodiment.

FIG. 6 illustrates diffraction characteristics for different photonic structures according to at least one example embodiment.

FIG. 7 illustrates various possibilities for photonic structures in unit cells according to at least one example embodiment.

### DESCRIPTION OF EMBODIMENTS

Photonic waveguides are promising optical building blocks for the development of Augmented Reality (AR)/Mixed Reality (MR) displays. Photonic waveguides employ multiple diffractive optical elements to replicate an image generated by optical engine (light source) and display the image to a user's eyes. Light from the optical engine propagates through the waveguide by Total Internal Reflection (TIR) and can be schematically divided into at least the following main functionalities: input pupil coupling, pupil replication (or expansion), replication, recycling, and output pupil coupling. The development of highly efficient AR/MR display requires the optimization of these three functionalities through the combination of photonic micro/ nanostructures. The photonic structures are used to control the path of the TIR light inside the waveguide as well as outcoupling of the light towards the user eye with the best image quality possible.

Among the above-mentioned functionalities, the recycling of the light offers a solution to increase the overall efficiency of the waveguide and increase the brightness of the displayed image. Recyclers are typically used on the periphery of the output coupling grating (OCG) to redirect the light escaping the emissive area, effectively enabling the OCG to recycle that light and increase the overall efficiency of the waveguide. Related art recyclers have one function which is to redirect the light towards the emitting OCG area. While these recyclers are useful to maximize the efficiency of the display, recyclers increase the overall footprint of the waveguide, require additional fabrication process steps, and do not directly contribute to light emitted to the eyebox. In addition, related art recyclers are made up of 1D or 2D gratings with one single recycling direction (a 1D diffraction order)—meaning that light is reflected back in only one direction (i.e., a direction opposite to the direction of light incoming to the recycler).

Embodiments of the present disclosure propose photonic structures for use in recyclers—called integrated recyclers—which simultaneously combine three main functionalities: 1) recycling, 2) redirecting light within the waveguide, and 3) output coupling of the light to the user's eyes. The integrated recyclers may be part of the output coupling grating area for a waveguide and contribute to improved brightness and uniformity of an AR/MR display. The integrated recyclers herein may comprise photonic structures that have up to eight 2-dimensional diffractive orders with the ratio between the diffraction efficiencies for light recycling light E_{rec}, redirecting light E_{red}, and outcoupling light to the user Eₒᵤₜ being tuned according to the position on the waveguide. As described in more detail below, the photonic structures may adhere to various design rules. For example, the photonic structures (also called photonic elements) are contained in a specific unit cell which are periodically repeated in two axes with defined pitches Λ_{PC1} and Λ_{PC2} to form a photonic crystal. Shapes of the unit cells and/or the photonic elements may be based on a reference shape, such as a parallelogram, and may be divided according to specific rules. Photonic elements may be stacked to provide a multi-layer structure that enhances functionality. The shapes of photonic elements may vary across the recycling region of the waveguide to increase image quality.

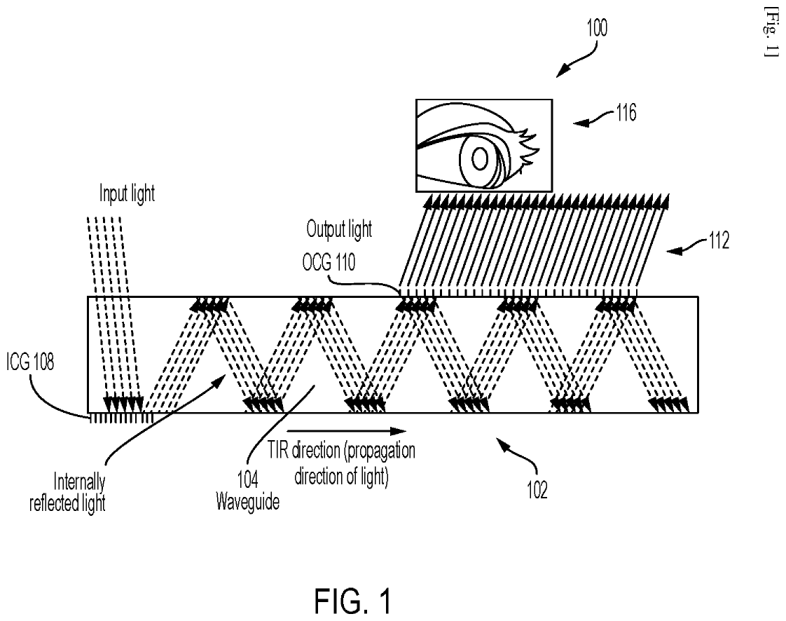

FIG. 1 is a block diagram of a system 100 including a display device 102 according to at least one example embodiment. The display device 102 may be a waveguide-based display and include a waveguide 104, an input coupling grating (ICG) 108, an output coupling grating (OCG) 110, and an eyebox 112 that outputs light to a user 116.

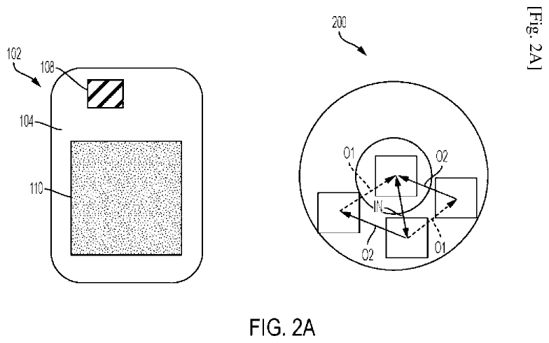

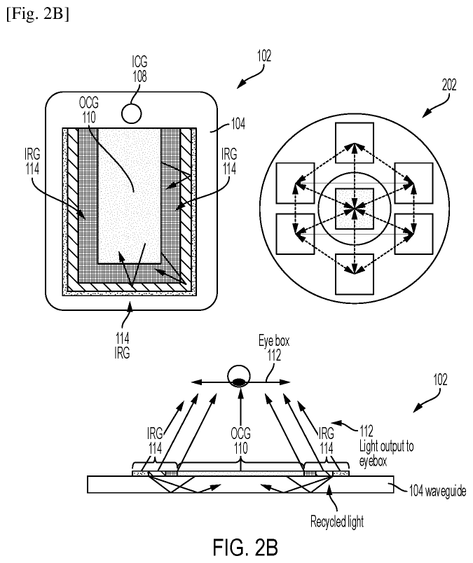

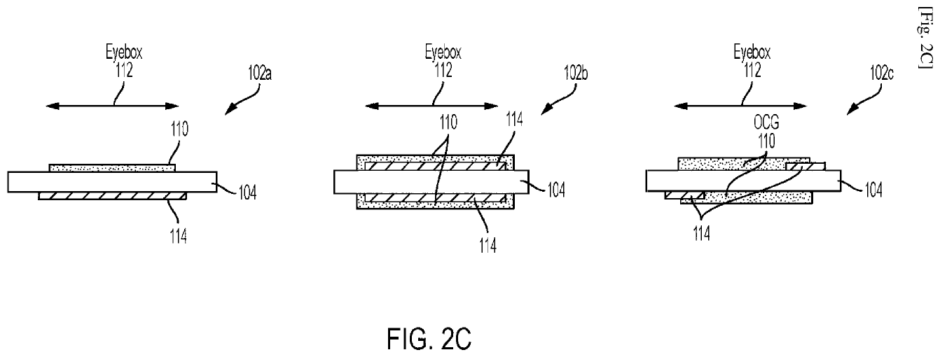

The waveguide 104 receives input light incident on a first surface of the waveguide 104 from a light source or an image generating device (not shown, but see FIG. 9 for additional detail of an image generating device). The received light is received by an input region of the ICG 108 on a first surface of the waveguide 104 and redirected (e.g., diffracted) at a propagation angle for internal reflection (e.g., total internal reflection (TIR) within the waveguide 104). The internally reflected light may travel within the waveguide 104 before encountering the OCG 110 at a second surface of the waveguide 104. The waveguide 104 may be fixed to or on a substrate or base (not illustrated). The OCG 110 has a structure that diffracts at least some of the internally reflected light to an eyebox 112 of the display device 102 as output light for viewing by the user 116. An area of the waveguide 104 located between the ICG 108 and OCG 110 may correspond to an expansion area. The input light may be generated by the light source under control of image processing circuitry (not shown) or an image generating device that controls the light source to output light in a manner that displays a still image and/or moving images to the user 116 through the eyebox 112, thereby providing an AR image or MR image to the user 116. The eyebox 112 may include an area or volume in which a user's eye will receive a view of the output light. The light source may comprise any suitable light source used for diffractive waveguide applications, for example, one or more light emitting diodes (LEDs) or other light source coupled with one or more lenses and/or prisms that direct light to the waveguide 104. As may be appreciated, FIG. 1 does not illustrate an integrated recycler, examples of which is described below with reference FIGS. 2B to 8.

The above mentioned image processing circuitry and image generating device may comprise a memory including executable instructions and a processor (e.g., a micro-processor) that executes the instructions on the memory. The memory may correspond to any suitable type of memory device or collection of memory devices configured to store instructions. Non-limiting examples of suitable memory devices that may be used include flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the image processing circuitry may comprise hardware, such as an application specific integrated circuit (ASIC). Other non-limiting examples of the image processing circuitry include an Integrated Circuit (IC) chip, a Central Processing Unit (CPU), a Graphics Processing Unit (GPU), a microprocessor, a Field Programmable Gate Array (FPGA), a digital signal processor (DSP), a collection of logic gates or transistors, resistors, capacitors, inductors, diodes, or the like. Some or all of the image processing circuitry may be provided on a Printed Circuit Board (PCB) or collection of PCBs. It should be appreciated that any appropriate type of electrical component or collection of electrical components may be suitable for inclusion in the image processing circuitry.

The waveguide 104 may comprise any suitable material for diffractive waveguide applications, for example, glass, plastic, polymer, or other suitable organic and/or inorganic optical material. The waveguide 104 may be implemented in any suitable manner. For example, the waveguide 104 may comprise a core and one or more cladding layers, where the core and the cladding layer(s) have different dielectric constants. In another example, the waveguide 104 may be implemented with silicon photonics.

As described herein, the ICG 108, OCG 110, and/or a recycler grating may comprise photonic structures (e.g., protrusions and/or indentations) at one or more surfaces of the waveguide 104. The ICG 108, OCG 110, and the recycler grating may be considered as Surface Relief Gratings (SRGs). FIG. 1 shows an example (without explicitly showing the recycler grating) where both the ICG 108 and OCG 110 are on a single surface of the waveguide 104 in the figure shown as the bottom surface for ICG 108 and top surface for OCG 110. However, the same or similar photonic structures may additionally or alternatively be on the opposite surface of the waveguide 104 (i.e., the top surface for ICG 108 and bottom surface for OCG 110). The photonic structures may be formed according to suitable methods, such as nanoimprint lithography methods and/or ink-jet printing methods. The photonic structures may be formed on the surface(s) of the waveguide 104 (i.e., the photonic structures are not part of the waveguide 104, but instead placed on the surface(s) of waveguide 104) and/or included as part of the surface(s) of the waveguide 104. The photonic structures may take a suitable shape or form. For example, the photonic structures may comprise one-dimensional structures (e.g., linear structures), two-dimensional structure (pillars, holes, and/or the like), metasurfaces, and/or other suitable form. In any event, the specific design of the photonic structures may be based on the optical characteristics desired for the output light of the display device 102. As described in more detail below, a recycler grating (IRG 114) and/or the OCG 110 may include photonic structures arranged into unit cells designed to improve brightness and uniformity of an image output to the eyebox 112.

The eyebox 112 may correspond to a volume of free space where the eyes of the user 116 receives a view of an image created by the light output from the OCG 110. The size and location of this volume may be based on optical architecture choices in which designers trade-off a number of constraints, such as field of view (FOV), image quality, and product design.

FIG. 2A illustrates a schematic view of a display device 102 and an example of a k-space design diagram for the display device 102 according to at least one example embodiment. As may be appreciated from the k-space design diagram 200, IN is the incoupling vector for ICG 108, while O1 and O2 are the expansion and outcoupling unit vectors, respectively, for the expansion area of the waveguide 104 and the OCG 110. As described herein, photonic structures may be divided into unit cells arranged at a substantially same pitch. The term “substantially” is used to account for variations in a value, such as pitch, that may occur as a result of the manufacturing process. Stated another way, the photonic structures are arranged at a substantially same pitch in that the pitch is within manufacturing tolerances. In some cases, the pitch is within some other acceptable deviation from a standard pitch value (e.g., within +/−5% of a standard pitch value).

Meanwhile, FIG. 2B illustrates schematic plan and cross-sectional views of a display device 102 that is similar to the display device in FIG. 2A except that FIG. 2B further illustrates an integrated recycler grating (IRG) 114, also called a recycler grating 114. FIG. 2B further illustrates an example k-space diagram for an IRG 114 that shows vectors for light recycling in solid lines and vectors for light redirection (e.g., redirection toward eyebox 112) in dashed lines (some of the dashed and solid lines overlap). As shown in the plan view of the schematical display device 102, an IRG 114 may surround the OCG 110 on at least three sides. As shown in the cross-sectional view, at least some parts of the IRG 114 have two simultaneous functions—redirecting light into the waveguide 104 back toward the OCG 110 as recycled light and outputting light toward the eyebox 112 as part of an image. The IRG 114 may be considered as “integrated” with the OCG 110 in that the IRG 114 causes light to be directed to the eyebox 112 like the OCG 110 while also causing light to be recycled back to the OCG 110. Notably, the IRG 114 differs from related art recycler gratings in that related art recycler gratings perform only one function—recycling light back to an OCG 110 or toward part of the waveguide 104 that will guide the recycled light to the OCG 110.

FIG. 2C illustrates additional cross-sectional views of example structures for a display device, labeled as display devices 102a to 102c. As may be appreciated, the arrangements shown in FIG. 2C for an OCG 110 and an IRG 114 differ from the arrangement shown in FIG. 2B. Display device 102a, for example, illustrates an OCG 110 on an eyebox 112 side of a waveguide 104 while an IRG 114 is separate from the OCG 110 and at the opposite side of the waveguide 104. Although not explicitly shown, the IRG 114 in display device 102a may have the same or similar plan view as in FIG. 2B. In some examples, the IRG 114 may overlap (e.g., completely overlap) with the OCG 110 in a plan view. Stated another, way, the footprint of the IRG 114 may be the same or larger than the footprint of the OCG 114. However, other layout configurations are also possible.

Meanwhile, display device 102b illustrates a structure where two IRGs 114 are fully integrated with respective OCGs 110 on two opposing sides of the waveguide 104. In this case, the footprint of each OCG 110 may be larger than the footprint of each IRG 114. However, other layout configurations are also possible.

Display device 102c illustrates OCGs 110 and IRGs 114 on opposing sides of the waveguide 104 with IRGs 114 being partially integrated with the OCGs 110 and located at opposite edges or ends of the waveguide 104.

It should be appreciated that OCG(s) 110 and IRG(s) 114 are not limited to the configurations illustrated herein and may exist in a variety of other configurations not explicitly illustrated or discussed.

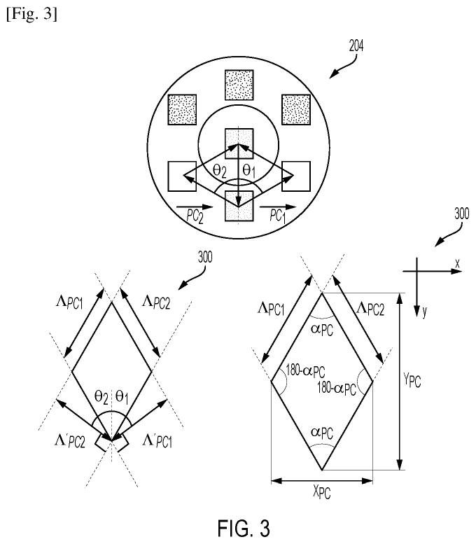

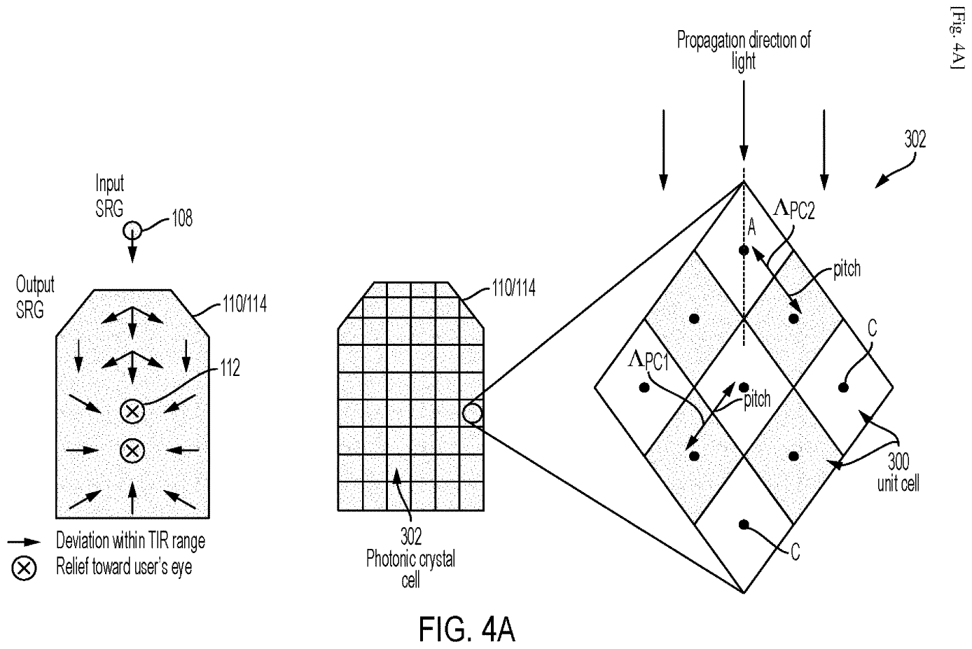

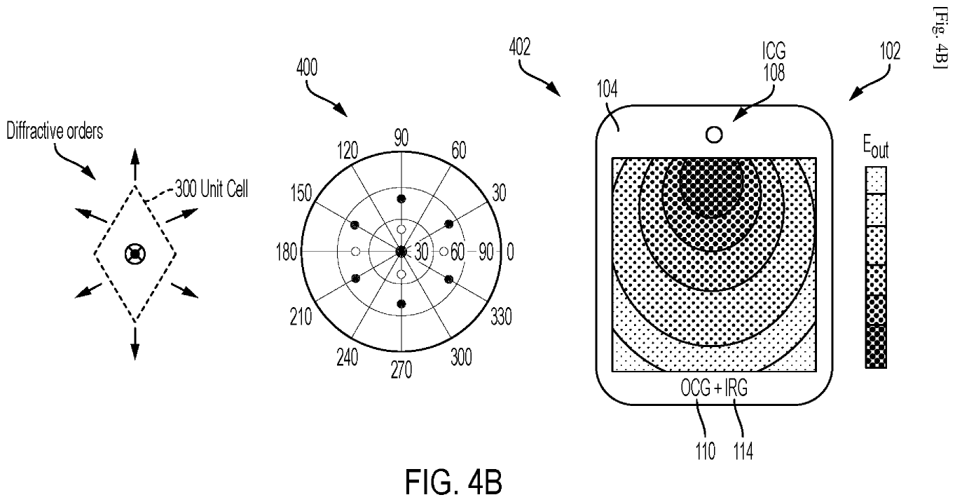

FIGS. 3 to 4B illustrate various details of an OCG 110 and an IRG 114 according to at least one example embodiment. More specifically, FIG. 3 illustrates a k-space design 204 that defines a unit cell 300 for an OCG 110 and/or an IRG 114, FIG. 4A illustrates a schematic structure of an OCG 110 and/or an IRG 114 including a plurality of unit cells 300, and FIG. 4B shows various other details for an OCG 110 and/or an IRG 114. As shown in FIG. 3, Λ′_{PC1} and Λ′_{PC2} are defined with grating vectors:

Λ_{PC1}=2π/|\vec{PC₁}|, Λ_{PC2}=2π/|\vec{PC₂}|.

The angles θ₁ and θ₂ are defined from the angle of grating vectors

\vec{PC₁} and \vec{PC₂}.

As may be appreciated, a unit cell 300 is formed by the intersection of two sets of parallel lines, forming a parallelogram shape.

FIG. 4A illustrates an OCG 110 and/or an IRG 114 design for spatially tuning the TIR light to accommodate for deviations in the waveguide and relief toward the user's eye, and FIG. 4B illustrates additional details for an OCG 110 and/or an IRG 114. As shown in FIG. 4A, the OCG 110 is divided into multiple regions 302, which may be referred to as photonic crystal cells 302. FIG. 4A illustrates an example where the regions 302 are rectangularly shaped and in a grid pattern on the OCG 110 and IRG 114. To the extent possible, each region 302 may have a substantially same surface area. However, the OCG 110 and/or IRG 114 may be divided differently so that regions 302 have a different size, a different shape, and/or are arranged in a different pattern. In some cases, the size, shape, and pattern of the regions 302 are selected to optimize image quality (e.g., brightness and uniformity) for the user. Notably, the regions 302 are virtual divisions used for the sake of mapping groups of unit cells 300 on an OCG 110 and/or an IRG 114 and do not necessarily exist as physical dividing lines on the OCG 110 and/or IRG 114.

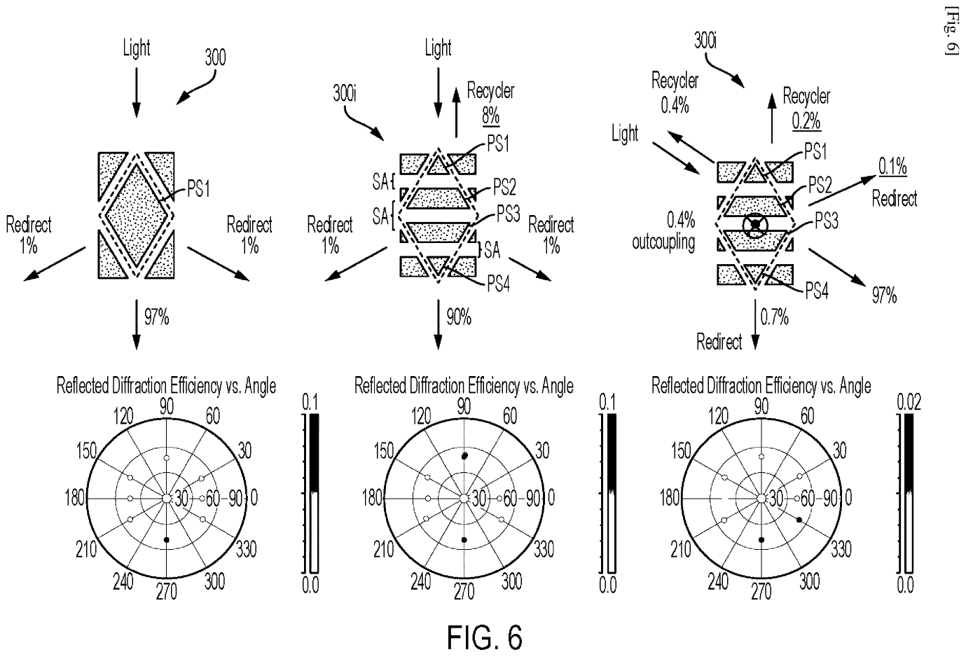

As further shown in FIG. 4A, each region 302 comprises a plurality of unit cells 300. The number of unit cells 300 in each region 302 may vary depending on design preferences. In some cases, the number of unit cells 300 is the same in each region 302. The unit cells 300 in a region 302 are periodically repeated along two non-parallel axes in a parallelogram geometry with Λ_{PC1} and Λ_{PC2} dimensions. Λ_{PC1} and Λ_{PC2} reflect the periodicity of the unit cell 300, and the values for Λ_{PC1} and Λ_{PC2} may depend on the operating wavelength, material properties, and/or design choice. In some examples, Λ_{PC1} and Λ_{PC2} are between 200 nm and 620 nm. In other examples, Λ_{PC1} and Λ_{PC2} are between 300 nm and 550 nm. In general, however, the values for Λ_{PC1} and Λ_{PC2} are equal to one another across the unit cells 300 in a region 302 or, in some cases, across all regions 302. In some cases, the values for Λ_{PC1} and Λ_{PC2} are equal to one another across the unit cells 300 in a region 302 or in all regions 302. In other cases, the values for Λ_{PC1} and Λ_{PC2} are different. With reference to FIG. 3, the shape of a unit cell 300 is defined by an angle α_{PC}—which is the smallest angle of the parallelogram defining the unit cell 300. The angle α_{PC} may be selected depending on the geometry of the desired Field of View (FOV) as represented in the k-space. The angle α_{PC} is between 30° and 90°, such as between 40° and 80°, or between 50° and 65°. As may be appreciated, the unit cells 300 in a particular region 302 may have a same size, a same shape, and a same orientation. In some examples, the unit cells 300 have a same size, a same shape, and a same orientation for all regions 302. As shown in FIG. 4A, a central axis A (e.g., a longitudinal axis) of a unit cell 300 may be aligned with the propagation direction of light in the waveguide 104 from an ICG 108. However, in some cases, the propagation direction of light is angled compared to the central axis A (see FIG. 6).

FIG. 4B illustrates additional details of an OCG 110 and an IRG 114 according to at least one example embodiment. For example, the left portion of FIG. 4B illustrates the possible diffractive orders of a unit cell 300 where the diffractive orders are controlled by one or more photonic structures in a unit cell 300 (see FIG. 6). As shown, a unit cell 300 may have 2D diffraction orders for a total of eight possible diffractive orders, represented by six arrows around the unit cell 300 with the notation in the middle of the unit cell 300 indicating two additional diffractive orders going into and coming out of the page. The unit cell 300 may be considered to be 2D in that light is potentially diffracted in two dimensions. The diagram 400 showing diffraction angle efficiency further emphasizes the eight possible diffractive orders with six dots surrounding a seventh dot that represents light diffracted into and out of the page. As may be appreciated, the diffraction efficiencies of an OCG 110 and/or an IRG 114 of a unit cell 300 are tuned according to the unit cell's 300 position within the larger grating so that each unit cell 300 achieves a desired amount of recycled light E_{rec}, redirected light E_{red}, and outcoupled light Eₒᵤₜ to the user via the eyebox 112. FIG. 4B further illustrates an example diffraction efficiency distribution 402 for an OCG 110 and IRG 114 for Eₒᵤₜ. In some examples, Eₒᵤₜ for an IRG 114 is tuned to be between 0.001% and 90% depending on a location of the IRG 114. For example, Eₒᵤₜ may be tuned to be higher for unit cells 300 of an IRG 114 that are closer to the OCG 110 to further enhance the image(s) provided to the eyebox 112.

In general and as discussed in more detail below, each unit cell 300 of an IRG 114 comprises one or more photonic structures PS. In some cases, each unit cell 300 of an IRG 114 comprises two or more photonic structures PS. All unit cells 300 in a particular region 302 may have same shaped, sized, and oriented photonic structures PS with the shape, size, and orientation of the photonic structures PS in a particular region 302 being selected to match a desired diffraction efficiency for that particular region 302. Because different diffraction efficiencies are used in different regions 302, the shapes, sizes, and/or orientation of photonic structures PS may vary between regions 302.

Stated another way, a plurality of unit cells 300 are arranged in groups on a base substrate of the OCG 110 and/or IRG 114, such as part of the waveguide 104. The OCG 110 and/or the IRG 114 is divided into the regions 302. Each region 302 comprises a group of unit cells 300 that contain substantially identical photonic structures in shape, size, and orientation. However, the size, shape, and/or orientation of photonic structures may vary between groups of unit cells. For example, unit cells of a first group corresponding to one of the regions 302 each include a first set of photonic structures in first orientations and having first sizes and first shapes. Meanwhile, unit cells of a second group corresponding to a different region 302 each include a second set of photonic structures in second orientations and having second sizes and second shapes. According to embodiments, at least one of the first orientations, the first sizes, and the first shapes of the first set of photonic structures is different than the second orientations, the second sizes, and the second shapes of the second set of photonic structures.

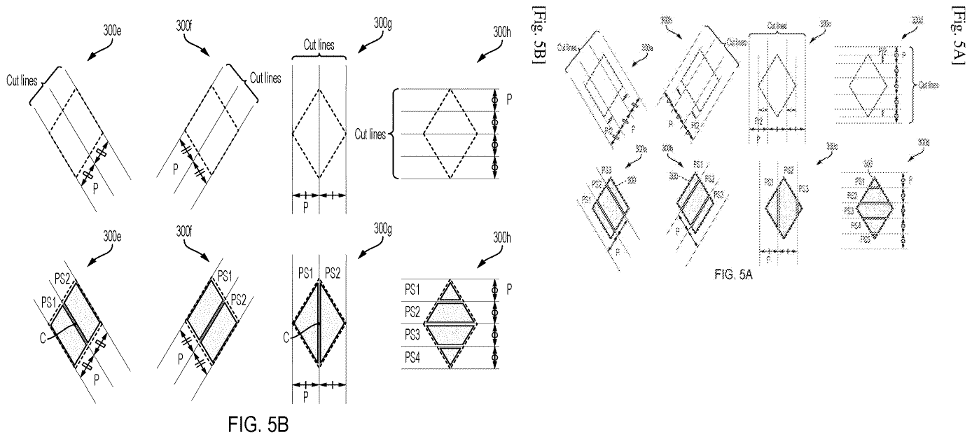

Notably, the present disclosure refers to size, shape, and orientation of structures from a plan view perspective of the structure being discussed, such as the views shown in FIGS. 5A-7. A photonic structure's size may be determined by the two-dimensional surface area (or footprint) of the photonic structure when viewed from the plan view without accounting for any variations in 3D profile. Size of a photonic structure may be measured by the amount of area (e.g., in percentage) the photonic structure occupies within a unit cell. Size of a unit cell may correspond to the two-dimensional surface area of the unit cell.

A photonic structure's shape may correspond to the two-dimensional shape when viewed from the plan view without accounting for any variations in 3D profile. Two photonic structures may be considered to have a same shape when each photonic structure has the same proportions of dimension (i.e., the only difference between the two structures is scale). Thus, two shapes having different proportions but same sizes (each occupies a same amount of area within a unit cell) are considered to have different shapes. In addition, two photonic structures of different sizes may be considered to have the same shape if the scale of the smaller sized shape can be enlarged to result in a structure that matches the dimensions of the larger sized shape.

A shape of a unit cell may correspond to the two-dimensional shape of the unit cell viewed from the plan view. Meanwhile, a photonic structure's orientation corresponds to the position of the photonic structure in 2D space relative to a reference when viewed from the plan view (the reference may correspond to a central axis of a unit cell). Orientation of a unit cell may correspond to the position of the unit cell in 2D space relative to a reference when viewed from the plan view (the reference may correspond to the propagation direction of light in FIG. 1, for example). In view of the above, it should be appreciated that two photonic structures from unit cells of different regions 302 may differ in one or more of shape, size, and orientation.

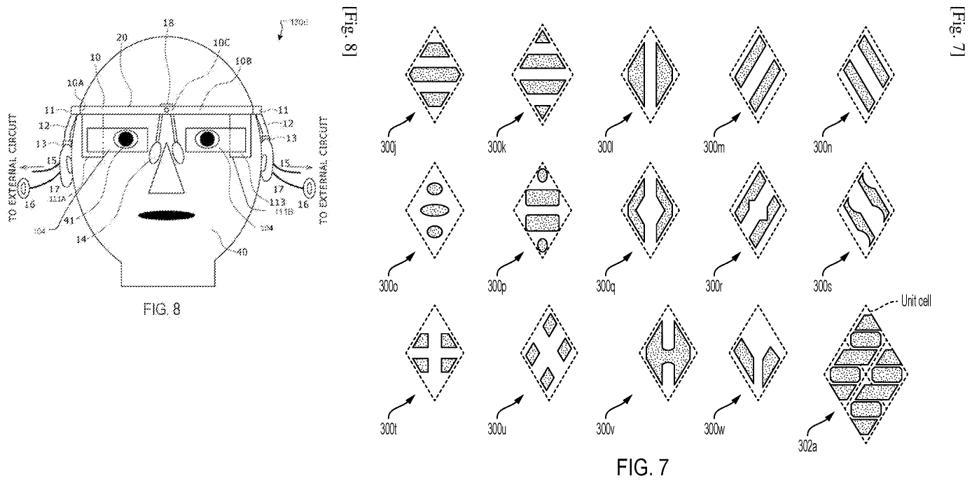

FIGS. 5A and 5B illustrate example divisions within unit cells 300a to 300h and corresponding photonic structures PS according to at least one example embodiment. As shown in the top of FIGS. 5A and 5B, each unit cell 300 may be divided into sub-areas defined by cut lines. Meanwhile, the bottom of FIGS. 5A and 5B illustrate layouts of photonic structures PS within each unit cell once divided in accordance with the cut lines. FIGS. 5A and 5B illustrate how each unit cell 300 comprises at least two photonic structures PS (e.g., PS1 to PS5) that are laid out between cut lines. As such, the cut lines may be considered virtual in that the cut lines are not necessarily physical cuts through a unit cell, but imaginary lines used for defining regions in which photonic structures PS of various shapes can exist (see FIG. 7 for a non-exhaustive illustration of possible shapes).

As may be appreciated, each unit cell 300a to 300h is divided by cut lines that adhere to one or more rules, defined as follows with reference to FIGS. 3-5B: 1) cutting/dividing a unit cell 300 occurs parallel to a) one of the sides Λ_{PC1} and Λ_{PC2} of the unit cell 300, b) one of the axes X_{PC} or Y_{PC} of the unit cell 300 (each axis X_{PC} and Y_{PC} comprises lines connecting the vertices of a parallelogram—X_{PC} and Y_{PC} do not necessarily have to be orthogonal), or c) both; 2) a pitch P between two adjacent cut lines parallel to the Λ_{PC1} side is Λ_{PC2}/m, with m being an integer equal to or greater than 2; 3) a pitch P between two adjacent cut lines parallel to the Λ_{PC2} side is Λ_{PC1}/m, with m being an integer equal to or greater than 2; 4) a pitch P between two adjacent cut lines parallel to the X_{PC} axis is Y_{PC}/2m, with m being an integer greater than 1; and 5) a pitch P between two cut lines parallel to the Y_{PC} axis is X_{PC}/2m, with m being an integer equal or greater than 1 (m≥1); 6) in rules 2-5, m is an integer (e.g., between 1 and 10), and in some cases m is between 1 and 3 (e.g., 2)—the integer m may be a design choice selected based desired diffraction efficiency; and 7) the cut lines for each unit cell 300 are arranged at a same pitch P. For ease of manufacture and/or mitigation of unwanted diffracted light within a unit cell 300, the cut lines may be at the middle of the sides Λ_{PC1} of Λ_{PC2} of a unit cell 300 (see 300e and 300f) or at quarters of the sides Λ_{PC1} of Λ_{PC2} of a unit cell 300 (not shown but corresponding to a unit cell 300a or 300b that is divided into quarters with one cut line passing through a center C of the unit cell), or the cut lines are centered along lines that correspond X_{PC}/2 (see 300g) or Y_{PC}/2 (not shown in FIGS. 5A and 5B but corresponding to a horizontal cut line like in unit cell 300d through a center C of a unit cell 300), or cut lines that correspond to Y_{PC}/4 (see 400h) or X_{PC}/4 (not shown in FIGS. 5A and 5B but corresponding to vertical cut lines like in unit cell 300c that divide the unit cell 300 into quarters with one cut line passing through a center C of the unit cell 300—see FIG. 6).

FIG. 6 illustrates diffraction characteristics, which includes graphs for reflected diffraction efficiency vs. angle, for two different photonic structures according to at least one example embodiment. The shaded regions in each unit cell correspond to the photonic structures while the unshaded regions may correspond to a layer under the photonic structures PS, such as a base substrate which may include or correspond to part of the waveguide 104 or another layer.

In more detail, the left side of FIG. 6 shows the diffraction characteristics for a unit cell 300 having a reference photonic structure PS1 (i.e., a photonic structure that is not modified by a cut line) when light enters from a direction the aligns with the Y_{PC} direction. As shown, 97% of the light is passed through to the other end of the photonic structure PS1 while 1% of the light is redirected out of opposite sides of the photonic structure PS1. Notably, any unaccounted for percentages in figures showing diffraction efficiencies may be due to inherent light loss. On the other hand, unit cell 300i includes photonic structures PS1 to PS4 that correspond to the reference photonic structure being cut along cut lines that adhere to the rules discussed above. In particular, unit cell 300i has been cut into quarters based on the Y_{PC}/4 rule noted above, where each neighboring photonic structure PS1 to PS4 is spaced apart by a substantially same spacing amount SA. FIG. 6 shows two diffraction efficiencies for two different scenarios where light enters the unit cell 300i from different directions. As shown for the left unit cell 300i, 8% of the incoming light is recycled (e.g., back toward the OCG 110) while 90% of the light passes through to the other end of the unit cell 300h with 1% of the light being redirected out of opposite sides of the unit cell 300i. As shown for the right unit cell 300i, the diffraction characteristics are different for light that enters the unit cell 300i at an angle in that 0.4% of the light is recycled in a direction opposite the direction of the light, 0.2% of the light is recycled in another direction, 97% of the light passes through to an opposite side of the unit cell 300i, 0.1% and 0.7% of the light is redirected as shown, and 0.4% of the light is outcoupling light (e.g., light that is directed out of (or into) the page toward the eyebox 112.

As may be appreciated, the shape, size, number, and/or orientation of photonic structures within a unit cell 300 may be adjusted depending on the unit cell's 300 position within the recycler grating to achieve desired diffraction characteristics. In general, though, photonic structures for recycler gratings adhere to the following rules: 1) the photonic structures PS are centered on one of the symmetry axes that passes through a center C of a unit cell 300 (e.g., X_{PC}/2, Y_{PC}/2, X_{PC}/4, Y_{PC}/4); 2) the photonic structures PS have a parallelogram shape, a triangular shape, a circular shape, or any combination thereof; 3) the photonic structures PS are implemented as a pillar (protrusion from a base substrate) or a hole (indentation into a base substrate); 4) each photonic structure PS has a single constant height between 5.0 nm and 300.0 nm, or between 5.0 nm and 200.0 nm, or multiple heights with each height being between 5.0 nm and 300.0 nm, or between 5.0 nm and 200.0 nm; and 5) spacing amounts SA between neighboring photonic structures PS inside a unit cell is greater than 5.0 nm, and in some cases kept greater than 20.0 nm. In addition, each photonic structure PS may be made of an organic polymer, a hybrid (organic/inorganic) resist, or an inorganic film such as glass. Each photonic structure PS may have a refractive index between 1.3 and 4.0 at a 590 nm wavelength of light. In some cases, a photonic structure PS is coated with a one or more coatings that have a refractive index between 1.3 and 2.4 at a 590 nm wavelength of light. Stated another way, photonic structures PS may be stacked on one another to enhance functionality. Each photonic structure PS within a unit cell 300 may have a same height, or the heights may vary across photonic structures in a unit cell 300.

FIG. 7 illustrates various possibilities for photonic structures PS in unit cells according to at least one example embodiment. As in other figures, the shaded regions correspond to photonic structures PS and the unshaded regions may correspond to a layer underneath the photonic structures PS (in the event that the photonic structures are pillared—if the photonic structures are holes, then the unshaded regions are elevated compared to the shaded regions). Unit cells 300j to 300n may be considered to contain photonic structures PS derived from a base or reference parallelogram shape (see left side of FIG. 6 for reference shape). Unit cells 300o to 300s illustrate non-limiting shape variations for the photonic structures that includes circle shapes/ ellipsoid shapes (300o, 300p), and parallelogram shapes (300p) as well as photonic structures with triangular and circular shaped cut outs (300q, 300r, 300s). Unit cell 300t is a combination of 300k and 300l and unit cell 300u is a combination of 300m and 300n. Unit cells 300v and 300w are meant to illustrate that it is possible for each photonic structure PS to contact or overlap with an edge of a unit cell. Unit cell 300v illustrates a case where a cut line is through a center of the unit cell but the two photonic structures are still connected over at least a section of the cut line. In some cases, a photonic structure PS of one unit cell spills into and forms part of a photonic structure PS of an adjacent unit cell as shown for an example region 302a having four unit cells with two pairs unit cells sharing a photonic structure.

In view of the above, it should be appreciated that the present disclosure proposes photonic structures PS that have recycling and outcoupling functions to enable control over the spatial diffraction efficiency in 3-dimensions which results in improved image brightness and uniformity.

FIG. 8 illustrates a schematic view of a head mounted display (HMD) 1300 according to at least one example embodiment.

The HMD 1300 may include a wearable frame 10 that supports elements of the HMD 1300, hinges 11 at ends 10A of the frame 10 that enable movement of temple portions 12 that hold the HMD 1300 to the head of an observer 40, ear pieces 13 that removably mount to ears of the observer 40, nose pads 14, wiring 15 that connects to an external processing circuit (not shown) where image processing operations are carried out, for example, on the basis of output from camera 18. The HMD 1300 may further include headphones 16, headphone wirings 17, an image sensor or camera 18 mounted to a face 10B of the frame 10 in a central portion 10C of the frame 10, a member 20 to which image generating devices 111A and 111B are mounted through, for example, a casing 113, and waveguides 104 that rest in front of pupils 41 of the observer 40 when wearing the HMD 1300. As may be appreciated, the image generating devices 111A and 111B may each include an optical system for providing input light to a respective waveguide 104. The optical system for each image generating device 111A and 111B may include one or more light sources, one or more lenses, one or more prisms or mirrors, one or more light modulators, and/or other suitable elements for generating input light for a waveguide 104. Each waveguide 104 take the form of one or more of the waveguides 104 discussed above with reference to FIGS. 1 to 8 and receive the input light shown in FIG. 1 from one of the image generating devices 111A and 111B.

Here, it should be appreciated that the above described details relate to one non-limiting example of an HMD 1300, and the HMD 1300 may include more or fewer elements than those illustrated and described above.

In view of FIGS. 1-8, it should be appreciated that example embodiments are directed to a recycler grating 114 for a waveguide-based display 102. The recycler grating 114 includes a base substrate, such as a waveguide 104 and/or a layer on the waveguide 104 between the waveguide and the grating. The recycler grating also includes a plurality of photonic structures PS arranged into groups of unit cells 300 on the base substrate. Each group may correspond to a region 302. For unit cells 300 in a first group, each unit cell 300 comprises a length measured in a first direction, a width measured in a second direction substantially perpendicular to the first direction, and first, second, third, and fourth sides. The first and second sides may be parallel to one another and extend in a third direction, and the third and fourth sides may be parallel to one another and extend in a fourth direction substantially perpendicular to the third direction. In some examples, each unit cell 300 comprises at least two photonic structures PS that are spaced apart from one another (e.g., spaced apart along at least one section of the PS) along a first cut line that extends in one of the first to fourth directions.

In some examples, the at least two photonic structures PS comprise a first photonic structure PS, a second photonic structure PS, and a third photonic structure PS, and the first and second photonic structures PS are spaced apart along the first cut line, and the second and third photonic structures PS are spaced apart along a second cut line (see FIGS. 5A and 5B). As shown in the figures, the second cut line may be substantially parallel to the first cut line.

In some cases, a spacing between the first cut line and the second cut line is derived from the length of the unit cell 300, the width of the unit cell 300, a length of one of the first or second sides, or a length of one of the third or fourth sides. For example, the spacing is derived from the length of the unit cell 300 when the first and cut lines are along the second direction, the spacing is derived from the width of the unit cell 300 when the first and cut lines are along the first direction, the spacing is derived from the length of one of the first and sides when the first and second cut lines are along the third direction, and when the spacing is derived from the length of one of the third or fourth sides when the first and second cut lines are along the fourth direction.

As shown in FIG. 5B, for example, the first cut line may pass through a center C of each unit cell 300. In some cases, as shown in FIG. 5A, the first cut line is offset from a center C of each unit cell. As shown in various figures, the at least two photonic structures PS create at least two lines of symmetry within each unit cell 300 (e.g., through the center C vertically and horizontally). In other cases, the at least two photonic structures PS do not have a line of symmetry within each unit cell 300. As shown in 302a of FIG. 7, the at least two photonic structures PS may comprise a photonic structure that extends into an adjacent unit cell. As shown in 300v of FIG. 7, the at least two photonic structures PS may be connected over a section of the first cut line.

For unit cells 300 in a second group (region 302), each unit cell in the second group comprises at least two photonic structures PS laid out differently compared to the at least two photonic structures in each unit cell of the first group. For example, the at least two photonic structures in each unit cell of the second group has at least one characteristic (e.g., size, shape, number of layers, and/or orientation) that differs from the photonic structures in each unit cell of the first group. In some cases, the unit cells 300 in all regions 302 or at least some regions 302 within an IRG 114 have a same size, shape, and orientation across all groups. As shown in the figures, at least some of the plurality of photonic structures PS redirect received light back into the base substrate and also out of the base substrate.

As may be appreciated from the figures and description herein, at least one embodiment is directed to a waveguide 104 for a display 102. The waveguide 104 may include an output coupling grating (OCG) 110 that outputs light to an eyebox of the display, and a recycler grating 114 that recycles light to the OCG and that outputs light to the eyebox. The waveguide 104 may further comprise an input coupling grating (ICG) that receives light from a light source (111A/111B). As shown in FIG. 2B, the recycler grating 114 surrounds at least three sides of the OCG 110 in a plan view. However, embodiments are not limited thereto and the recycler grating 114 may be on one or two sides of the grating 114. As shown in the figures, the recycler grating 114 comprises a plurality of photonic structures PS arranged into groups of unit cells 300. Each unit cell 300 may comprise at least two photonic structures PS.

A head mounted display (HMD) may comprise one or more of the above described elements. For example, an HMD may include a waveguide 104 comprising an input coupling grating (ICG) 108 that receives light from the light source, an output coupling grating (OCG) 110 that outputs light to an eyebox 112 of the HMD, and a recycler grating 114 that recycles light to the OCG and that outputs light to the eyebox. The recycler grating 114 may comprise a plurality of photonic structures PS arranged into groups of unit cells 300 with each unit cell 300 in each group comprising at least two photonic structures PS. At least some of the plurality of photonic structures PS recycle light to the OCG 110 and also output light to the eyebox 112.

The embodiments described with reference to FIGS. 1-8 may be combined with one another in any suitable manner.

While this technology has been described in conjunction with a number of embodiments, it is evident that many alternatives, modifications and variations would be or are apparent to those of ordinary skill in the applicable arts. Accordingly, it is intended to embrace all such alternatives, modifications, equivalents, and variations that are within the spirit and scope of this disclosure.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/ features/embodiments in combination with any one or more other aspects/ features/embodiments, use of any one or more of the embodiments or features as disclosed herein. It is to be appreciated that any feature described herein can be claimed in combination with any other feature(s) as described herein, regardless of whether the features come from the same described embodiment.

Any processing devices, control units, processing units, etc. discussed above may correspond to one or many computer processing devices, such as a Field Programmable Gate Array (FPGA), an Application-Specific Integrated Circuit (ASIC), any other type of Integrated Circuit (IC) chip, a collection of IC chips, a micro-controller, a collection of microcontrollers, a microprocessor, Central Processing Unit (CPU), a digital signal processor (DSP) or plurality of microprocessors that are configured to execute the instructions sets stored in memory.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as an embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

Various aspects of the present disclosure are described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Example embodiments may be configured according to the following:
(1)

A recycler grating for a waveguide-based display, comprising:
a base substrate; and
a plurality of photonic structures arranged into groups of unit cells on the base substrate, wherein for unit cells in a first group:
each unit cell comprises a length measured in a first direction, a width measured in a second direction substantially perpendicular to the first direction, and first, second, third, and fourth sides, wherein the first and second sides are parallel to one another and extend in a third direction, and wherein the third and fourth sides are parallel to one another and extend in a fourth direction substantially perpendicular to the third direction; and
each unit cell comprises at least two photonic structures that are spaced apart from one another in at least one section along a first cut line that extends in one of the first to fourth directions.
(2)

The recycler grating of (1), wherein the at least two photonic structures comprise a first photonic structure, a second photonic structure, and a third photonic structure, and wherein the first and second photonic structures are spaced apart along the first cut line, and wherein the second and third photonic structures are spaced apart along a second cut line.
(3)

The recycler grating of one or more of (1) to (2), wherein the second cut line is substantially parallel to the first cut line.
(4)

The recycler grating of one or more of (1) to (3), wherein a spacing between the first cut line and the second cut line is derived from the length of the unit cell, the width of the unit cell, a length of one of the first or second sides, or a length of one of the third or fourth sides.
(5)

The recycler grating of one or more of (1) to (4), wherein the spacing is derived from the length of the unit cell when the first and cut lines are along the second direction, wherein the spacing is derived from the width of the unit cell when the first and cut lines are along the first direction, wherein the spacing is derived from the length of one of the first and sides when the first and second cut lines are along the third direction, and when the spacing is derived from the length of one of the third or fourth sides when the first and second cut lines are along the fourth direction.
(6)

The recycler grating of one or more of (1) to (5), wherein the first cut line passes through a center of each unit cell.
(7)

The recycler grating of one or more of (1) to (6), wherein the first cut line is offset from a center of each unit cell.
(8)

The recycler grating of one or more of (1) to (7), wherein the at least two photonic structures create at least two lines of symmetry within each unit cell.
(9)

The recycler grating of one or more of (1) to (8), wherein the at least two photonic structures do not have a line of symmetry within each unit cell.
(10)

The recycler grating of one or more of (1) to (9), wherein the at least two photonic structures comprise a photonic structure that extends into an adjacent unit cell.
(11)

The recycler grating of one or more of (1) to (10), wherein the at least two photonic structures are connected over a section of the first cut line.
(12)

The recycler grating of one or more of (1) to (11), wherein, for unit cells in a second group, each unit cell in the second group comprises at least two photonic structures laid out differently compared to the at least two photonic structures in each unit cell of the first group.
(13)

The recycler grating of one or more of (1) to (12), wherein the unit cells have a same size, shape, and orientation across all groups.
(14)

The recycler grating of one or more of (1) to (13), wherein at least some of the plurality of photonic structures redirect received light back into the base substrate and also out of the base substrate.
(15)

A waveguide for a display, comprising:
an output coupling grating (OCG) that outputs light to an eyebox of the display; and
a recycler grating that recycles light to the OCG and that outputs light to the eyebox;
(16)

The waveguide of (15), further comprising: an input coupling grating (ICG) that receives light from a light source.
(17)

The waveguide of one or more of (15) to (16), wherein the recycler grating surrounds at least three sides of the OCG in a plan view.
(18)

The waveguide of one or more of (15) to (17), wherein the recycler grating comprises: a plurality of photonic structures arranged into groups of unit cells, wherein each unit cell comprises at least two photonic structures.
(19)

A head mounted display (HMD), comprising:
a light source; and
a waveguide comprising:
an input coupling grating (ICG) that receives light from the light source;
an output coupling grating (OCG) that outputs light to an eyebox of the HMD; and
a recycler grating that recycles light to the OCG and that outputs light to the eyebox.
(20)

The HMD of (19), wherein the recycler grating comprises a plurality of photonic structures arranged into groups of unit cells, wherein each unit cell in each group comprises at least two photonic structures, and wherein at least some of the plurality of photonic structures recycle light to the OCG and also output light to the eyebox.

What is claimed is:

1. A recycler grating for a waveguide-based display, comprising:
a base substrate; and
a plurality of photonic structures arranged into groups of unit cells on the base substrate, wherein for unit cells in a first group:
each unit cell comprises a length measured in a first direction, a width measured in a second direction substantially perpendicular to the first direction, and first, second, third, and fourth sides, wherein the first and second sides are parallel to one another and extend in a third direction, and wherein the third and fourth sides are parallel to one another and extend in a fourth direction substantially perpendicular to the third direction; and
each unit cell comprises at least two photonic structures that are spaced apart from one another in at least one section along a first cut line that extends in one of the first to fourth directions.

2. The recycler grating of claim 1, wherein the at least two photonic structures comprise a first photonic structure, a second photonic structure, and a third photonic structure, and wherein the first and second photonic structures are spaced apart along the first cut line, and wherein the second and third photonic structures are spaced apart along a second cut line.

3. The recycler grating of claim 2, wherein the second cut line is substantially parallel to the first cut line.

4. The recycler grating of claim 3, wherein a spacing between the first cut line and the second cut line is derived from the length of the unit cell, the width of the unit cell, a length of one of the first or second sides, or a length of one of the third or fourth sides.

5. The recycler grating of claim 4, wherein the spacing is derived from the length of the unit cell when the first and cut lines are along the second direction, wherein the spacing is derived from the width of the unit cell when the first and cut lines are along the first direction, wherein the spacing is derived from the length of one of the first and sides when the first and second cut lines are along the third direction, and when the spacing is derived from the length of one of the third or fourth sides when the first and second cut lines are along the fourth direction.

6. The recycler grating of claim 1, wherein the first cut line passes through a center of each unit cell.

7. The recycler grating of claim 1, wherein the first cut line is offset from a center of each unit cell.

8. The recycler grating of claim 1, wherein the at least two photonic structures create at least two lines of symmetry within each unit cell.

9. The recycler grating of claim 1, wherein the at least two photonic structures do not have a line of symmetry within each unit cell.

10. The recycler grating of claim 1, wherein the at least two photonic structures comprise a photonic structure that extends into an adjacent unit cell.

11. The recycler grating of claim 1, wherein the at least two photonic structures are connected over a section of the first cut line.

12. The recycler grating of claim 1, wherein, for unit cells in a second group, each unit cell in the second group comprises at least two photonic structures laid out differently compared to the at least two photonic structures in each unit cell of the first group.

13. The recycler grating of claim 1, wherein the unit cells have a same size, shape, and orientation across all groups.

14. The recycler grating of claim 1, wherein at least some of the plurality of photonic structures redirect received light back into the base substrate and also out of the base substrate.

15. A waveguide for a display, comprising:
an output coupling grating (OCG) that outputs light to an eyebox of the display; and
a recycler grating that recycles light to the OCG and that outputs light to the eyebox.

16. The waveguide of claim 15, further comprising:
an input coupling grating (ICG) that receives light from a light source.

17. The waveguide of claim 15, wherein the recycler grating surrounds at least three sides of the OCG in a plan view.

18. The waveguide of claim 15, wherein the recycler grating comprises:
a plurality of photonic structures arranged into groups of unit cells, wherein each unit cell comprises at least two photonic structures.

19. A head mounted display (HMD), comprising:
a light source; and
a waveguide comprising:
an input coupling grating (ICG) that receives light from the light source;
an output coupling grating (OCG) that outputs light to an eyebox of the HMD; and
a recycler grating that recycles light to the OCG and that outputs light to the eyebox.

20. The HMD of claim 19, wherein the recycler grating comprises a plurality of photonic structures arranged into groups of unit cells, wherein each unit cell in each group comprises at least two photonic structures, and wherein at least some of the plurality of photonic structures recycle light to the OCG and also output light to the eyebox.
